(19) United States
(12) Patent Application Publication
(10) Pub. No.: US 2018/0110373 A1
(43) Pub. Date: Apr. 26, 2018

(54) FOOD PROCESSOR WITH IMPROVED STEAM CHANNEL STRUCTURE

(71) Applicant: KONINKLIJKE PHILIPS N.V., EINDHOVEN (NL)

(72) Inventors: WEI ZHANG, SHANGHAI (CN); HUA LIU, SHANGHAI (CN); YOYOU WANG, SHANGHAI (CN)

(21) Appl. No.: 15/427,689

(22) Filed: Feb. 8, 2017

(30) Foreign Application Priority Data
Oct. 21, 2016 (CN) PCT/CN2016/102890

(51) Int. Cl. A47J 43/07; A47J 43/08

(52) U.S. Cl. CPC A47J 43/07; A47J 43/08; A47J 43/0722

(57) ABSTRACT

The invention relates to a food processor comprising a steam generator and a heating cup, wherein the heating cup comprises a container and a removable lid for sealing the container, the steam generator being coupled to the heating cup via a steam inlet arranged in the lid, the steam inlet being an opening of a steam pipe arranged in the lid and configured to dispense steam in the container when the lid seals the container.

### FIELD OF THE INVENTION

The invention relates to a heating cup having a specific steam channel structure and to a food processor comprising such a heating cup.

### BACKGROUND OF THE INVENTION

FIGS. 1 and 2 of U.S. patent application No. 2014251162 shows a food processor comprising a processor body, a steam generation device and a heating cup. The heating cup is provided with a steam inlet and a steam outlet. A steaming cup is arranged in the heating cup. An air hole is provided at a bottom wall of the steaming cup. A first gap and a second gap in communication with each other are respectively arranged between a side wall of the steaming cup and a side wall of the heating cup, and between the bottom wall of the steaming cup and a bottom wall of the heating cup. The steam channel has the following structure: a steam inflow channel is arranged in the first gap, and steam diffuses from the steam inlet on the heating cup towards two sides to enter the steam inflow channel, and enters the steaming cup through the air hole after entering the second gap from the steam inflow channel.

Such a steam channel has a simple structure and a large steam flow but can suffer from some heat loss which may decrease the heating efficiency. Such a heating cup may also not be fully safe for the end user.

### SUMMARY OF THE INVENTION

It is an object of the present invention to propose a food processor that has better performances than the one of the prior art.

In accordance with a first aspect of the invention, it is proposed a food processor comprising a steam generator and a heating cup, wherein the heating cup comprises a container and a removable lid for sealing the container, the steam generator being coupled to the heating cup via a steam inlet arranged in the lid, the steam inlet being an opening of a steam pipe arranged in the lid and configured to dispense steam in the container when the lid seals the container.

Because the steam inlet is provided in the lid, whereas it is provided in the container in the prior art, steam can only be dispensed in the heating cup when the lid seals the container, which makes the food processor safer since the user can hardly be burned by hot steam.

According to an embodiment of the invention, the heating cup comprises a basket arranged in the container for receiving food, a steam channel being formed in a side wall of the basket so as to connect to the steam pipe when the lid seals the container.

Since the steam channel is directly included in a side wall of the basket, the steam is directly guided to the bottom of basket with limited heat loss and the heating efficiency is increased.

According to another embodiment of the invention, the steam inlet is arranged in a side wall of the lid and the steam pipe forms approximately a right angle.

Because the steam pipe forms a right angle, the high speed rotating food particles cannot fly into the steam generator when foods are blended in the heating cup.

Still according to another embodiment of the invention, the lid comprises a steam outlet on its top for letting the steam escape from the container.

Since the steam outlet is on the top of the lid, whereas it is on a side wall of the container in the prior art, the steam can escape easily and safely.

In accordance with another aspect of the invention, it is proposed a heating cup comprising a container and a removable lid for sealing the container, the heating cup being coupled to a steam generator for receiving steam via a steam inlet arranged in the lid, the steam inlet being an opening of a steam pipe arranged in the lid and configured to dispense steam in the container when the lid seals the container

### BRIEF DESCRIPTION OF THE DRAWING

The present invention will now be described in more detail, by way of example, with reference to the accompanying drawing, wherein:

FIG. 1 is a schematic view of the a food processor according to the prior art,

FIG. 2 shows the operation of a food processor in accordance with the prior art,

FIG. 3 shows a cross section view of a first embodiment of a heating cup in accordance with the invention,

FIG. 4 shows a cross section view of a second embodiment of a heating cup in accordance with the invention, and

FIG. 5 shows the heating cup in accordance with the invention when food is blended.

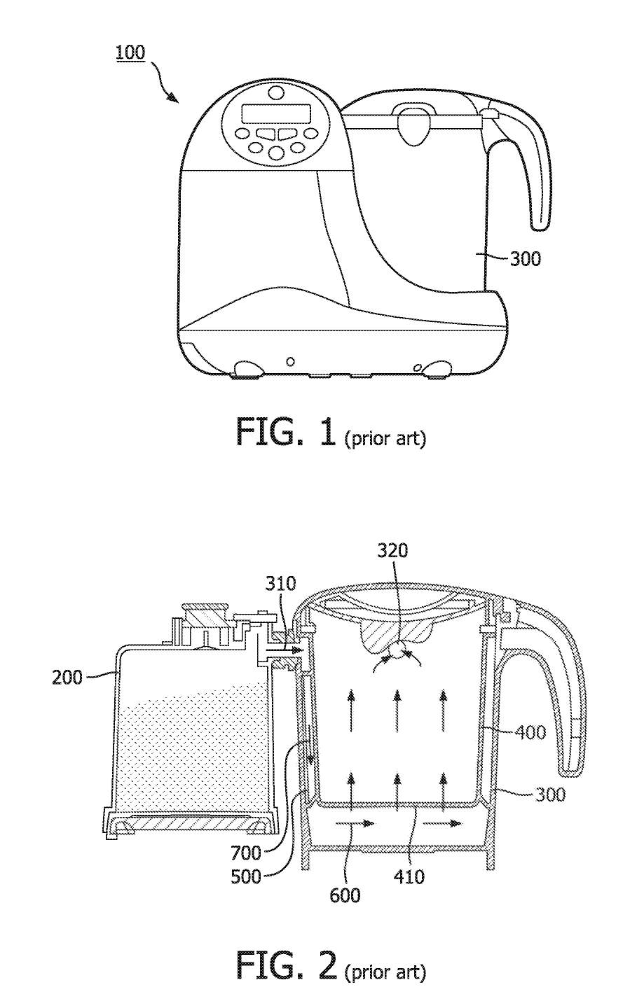

### DETAILED DESCRIPTION OF THE INVENTION

The invention relates to a food processor comprising a steam generator for generating steam and a heating cup connected to the steam generator for receiving the steam and for steaming food.

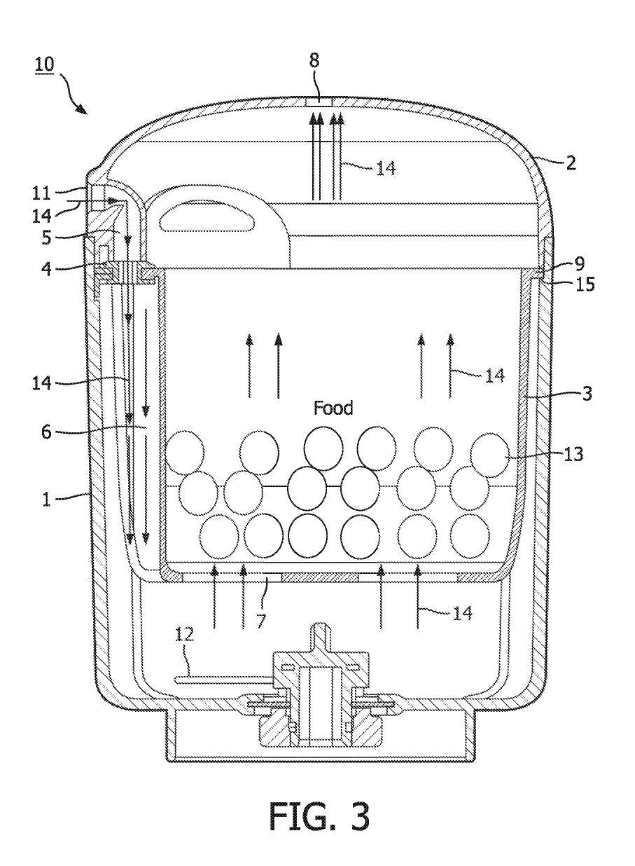

FIG. 3 is a cross section view of a heating cup in accordance with the invention. The heating cup comprises a container and a removable lid for sealing the container. A steam basket is arranged in the container for receiving the food to be steamed. The container comprises a step around its inner wall and the basket comprises a flange around its main opening for placing the basket on the step.

The steam generator (not represented) is adapted to convert liquid such as water to high temperature steam. The steam generator comprises a steam nozzle (also not represented) that is hermetically coupled to the lid of the heating cup via a steam inlet. The steam inlet forms an opening of a steam pipe arranged in the lid. The steam pipe is configured to dispense steam in the container when the lid seals the container. The steam flow is represented by arrows in FIG. 3. Another opening of the steam pipe connects to a hole on the flange of the basket via a rubber seal. The rubber seal is fixed on the steam pipe or on the hole.

According to the embodiment of FIG. 3, the steam inlet is on a side wall of the lid and the steam pipe forms approximately a right angle. At the top of the lid there is at least one steam venting hole. A bottom part of the basket comprises one or more apertures for making the steam heat the food. Finally, the container comprises in its bottom part a cutter to cut or blend the food, the cutter comprising at less one blade.

In operation, food is put in the basket, the basket is placed into the container, and the user closes the container with the lid. The user can then turn on the heater located under the steam generator which is filled with water, and the steam generator starts to generate steam. The steam flows from the steam nozzle of the steam generator to the steam pipe. The steam flows along the steam pipe and then via the hole in the flange of basket into the space a space between a side wall of the container and a side wall of the basket thus forming a steam channel.

Since the flange blocks the upward path, the steam has to move down to the space below the basket. The steam flow then rises up through the apertures on the bottom of the basket, and then steam the food from bottom. Finally, the steam is released from the venting hole on the top wall of the lid or the gap between the container and the lid. Steaming from bottom makes food heat up more completely and evenly.

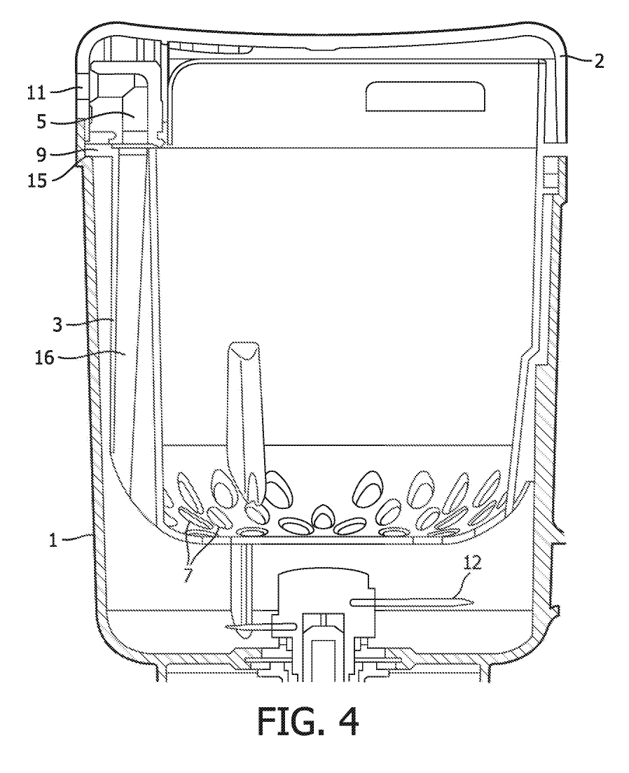

FIG. 4 is a cross section view of a second embodiment of a heating cup in accordance with the invention. The heating cup comprises a container and a removable lid for sealing the container. A steam basket is arranged in the container for receiving the food to be steamed. The container comprises a step around its inner wall and the basket comprises a flange around its main opening for placing the basket on the step.

A steam channel is formed in a side wall of the basket so as to connect, preferably hermetically, to the steam pipe when the lid seals the container. Since the steam channel is formed in the basket wall, there is no steam leakage and the heat loss is minimized compared to the previous embodiment where thermal energy can be lost by heat exchange through the container wall to the external environment. Here the steam channel in the basket can isolate the steam heat.

The steam flow is represented by arrows. A bottom part of the basket comprises one or more apertures for making the steam heat the food. The container comprises in its bottom part a cutter to cut or blend the food, the cutter comprising at less one blade.

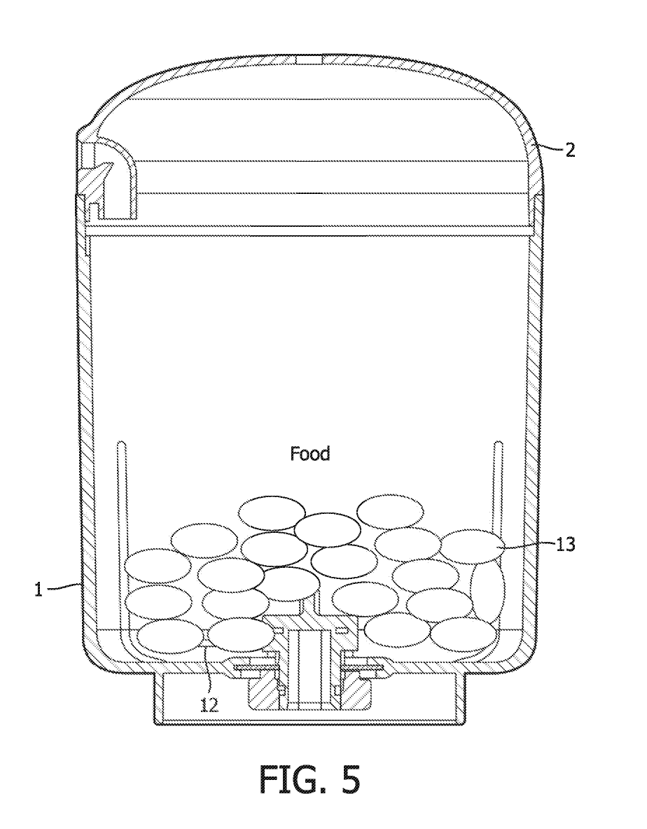

FIG. 5 shows the heating cup in accordance with the invention when the food is blended. After steaming, the lid is removed and the steamed food is poured into the container. The basket is put aside and the lid is closed. A dedicated button of the food processor is then turned on such that the cutting/blending function is activated to blend food. Because of the angled steam path of the steam pipe, the high speed rotating food particles cannot fly into the steam nozzle of the steam generator.

In the present specification and claims the word “a” or “an” preceding an element does not exclude the presence of a plurality of such elements. Further, the word “comprising” does not exclude the presence of other elements or steps than those listed.

The inclusion of reference signs in parentheses in the claims is intended to aid understanding and is not intended to be limiting.

From reading the present disclosure, other modifications will be apparent to persons skilled in the art. Such modifications may involve other features which are already known in the art and which may be used instead of or in addition to features already described herein.

1. A food processor comprising a steam generator and a heating cup, wherein the heating cup comprises a container and a removable lid for sealing the container, the steam generator being coupled to the heating cup via a steam inlet arranged in the lid, the steam inlet being an opening of a steam pipe arranged in the lid and configured to dispense steam in the container when the lid seals the container.

2. A food processor as claimed in claim 1, comprising a basket arranged in the container for receiving food, a steam channel being formed in a side wall of the basket so as to connect to the steam pipe when the lid seals the container.

3. A food processor as claimed in claim 1, wherein the container comprises a step around its inner wall and the basket comprises a flange around its opening for placing the basket on the step.

4. A food processor as claimed in claim 1, comprising a basket arranged in the container for receiving food, a steam channel being formed in a space between a side wall of the container and a side wall of the basket for receiving the steam dispensed by the steam pipe.

5. A food processor as claimed in claim 2, wherein a bottom part of the basket comprises one or more apertures for making the steam heat the food.

6. A food processor as claimed in claim 1, wherein the steam inlet is arranged in a side wall of the lid and the steam pipe forms approximately a right angle.

7. A food processor as claimed in claim 1, wherein the lid comprises on its top a steam outlet for letting the steam escape from the container.

8. A food processor as claimed in claim 1, comprising a cutter for mixing the food.

9. A heating cup comprising a container and a removable lid for sealing the container, the heating cup being coupled to a steam generator for receiving steam via a steam inlet arranged in the lid, the steam inlet being an opening of a steam pipe arranged in the lid and configured to dispense steam in the container when the lid seals the container.
